(19) United States
(12) Patent Application Publication
(10) Pub. No.: US 2011/0276966 A1
(43) Pub. Date: Nov. 10, 2011

(54) Managing task dependency within a data processing system

(75) Inventors: Aske Simon Christensen, Trondheim (NO); Sean Ellis, Farnham (GB); Andreas Engh-Halstvedt, Trondheim (NO)

(73) Assignee: ARM LIMITED, Cambridge (GB)

(21) Appl. No.: 12/662,857

(22) Filed: May 6, 2010

(51) Int. Cl. G06F 9/46

(52) U.S. Cl. 718/100

(57) ABSTRACT

A processing apparatus includes task manager circuitry 14 issuing task specifiers to processing circuitry 16, 18, 20, 22, 24 indicating processing tasks to be performed. The task specifier includes a relaxed dependency identifier to which the processing circuitry is responsive. The processing circuitry responds to the relaxed dependency identifier by starting the processing task concerned and then controlling the processing task concerned in dependency upon the status of the other processing task upon which there is a relaxed dependency. The task specifier may also indicate a strict dependency in which a processing task may not be started until the other processing task has completed as well as a no dependency indication in which the processing task may be started without reference to any other processing task.

### BACKGROUND OF THE INVENTION

1. Field of the Invention

This invention relates to the field of data processing systems. More particularly, this invention relates to managing the dependency between different processing tasks to be performed.

2. Description of the Prior Art

It is known to provide data processing systems which divide an overall processing workload into a plurality of processing tasks to be performed. These processing tasks may then be issued to be performed by the processing hardware in a manner seeking to increase the level of parallelism within the processing performed. Different processing tasks which have no dependency between them may be executed in parallel and accordingly speed up the overall processing. However, it is normal for some of the processing tasks to have a dependency on some number of other tasks (zero or more). As an example, one processing task may require as its inputs the output values generated by another processing task. This is normally dealt with by requiring the processing task generating the outputs to have completed processing before the processing task requiring those outputs is permitted to start processing.

In order to manage this dependency between processing tasks, it is known to provide dependency information associated with tasks to be processed. This dependency information specifies other tasks which must be completed before the task associated with that dependency information is started. While such an arrangement ensures dependency requirements are not violated, it suffers from a disadvantage of restricting the ability to start tasks in parallel.

### SUMMARY OF THE INVENTION

Viewed from one aspect the present invention provides apparatus for processing data comprising:

processing circuitry configured to respond to a task specifier to perform a processing task specified by said task specifier; and

a task manager configured to issue said task specifier to said processing circuitry, said task specifier identifying zero, one or more dependencies between said processing task and other processing tasks; wherein

when said task specifier identifies a relaxed dependency between said processing task and an other processing task, said processing circuitry is responsive to said relaxed dependency:

(i) to control performing of said processing task by said processing circuitry in dependency upon a status of said other processing task; and

(ii) to permit said processing circuitry to start performing said processing task before completion of said other processing task.

The task specifier may identify zero, one or more dependencies between the processing task and other processing tasks. These dependencies can vary in their nature. If the number of dependencies is zero then the processing task has no dependency on any other processing task. The present technique recognises that control of dependency may be achieved other than by merely preventing a task from starting processing until any task upon which it depends has completed processing. More particularly, the present technique provides a task specifier issued to the processing circuitry for performing a task which identifies a relaxed dependency between the processing task to be performed and at least one other processing task. This relaxed dependency permits the processing task to start but controls the performing of that processing task in dependency upon a status of at least one other processing task. This relaxed dependency can be utilised where an appropriate relationship exists between processing tasks to permit a higher degree of parallel processing to be achieved whilst respecting the dependency requirements of the processing tasks concerned.

The task specifier which identifies the relaxed dependency may, in some embodiments, additionally be used to identify other dependency relationships, such as a strict dependency or no dependency. If a strict dependency is specified, then before the processing task is started the other processing task to which the dependency lies must have completed its operation. When no dependency is identified, then the processing task may be started without dependency upon any other processing task. Thus, the task specifier in such embodiments is able to express at least three types of dependency, namely strict dependency, relaxed dependency and no dependency.

The dependency requirement which is indicated by an identification of a relaxed dependency may vary with the different processing tasks concerned. In some embodiments the other processing task generates a plurality of outputs and the status of the other processing task upon which the relaxed dependency controls the processing task is that the other processing task has generated a predetermined portion of its outputs. As an example, the other processing task may generate a sequence of outputs which are then consumed as inputs within the processing task having the relaxed dependency. If the processing task having the relaxed dependency consumes the outputs of the other processing task in roughly the same order in which they were generated, then there is no need for the processing task to wait until all of those outputs have been generated in order that it may start. In practice the relaxed dependency may indicate that after a certain portion of those outputs have been generated by the other processing task, then these will be sufficient to serve as the inputs to the processing task having the relaxed dependency and it may start its operation. This contrasts with a strict dependency requirement in which the processing task would wait until all of the outputs of the other processing task had been generated upon its completion before starting the processing task even though the outputs of that other processing task which were initially required may have been available for some time prior to completion of the other processing task.

Another type of dependency which may be represented by a relaxed dependency is that the other processing task can generate one or more state variables at least in time for those one or more state variables being required for use by the processing task having that relaxed dependency. These state variables may or may not be outputs of the processing task and may merely be that the other processing task has reached a certain stage in its processing, e.g. is committed to a processing pipeline such that it will be processed without task reordering subsequent to that time. A further example of this type of relaxed dependency may be when the other processing task and the processing task having the relaxed dependency both accesses sequences of data items in order and the access to the sequence by the other processing task updates a pointer value with this pointer value indicating an access position to be used within the sequence by the processing task having the relaxed dependency. Thus, the other processing task is required to have made its access and update the pointer before the processing task having the relaxed dependency makes its access.

It will be appreciated by those in this technical field that other forms of dependency may exist between processing tasks which are suitable for control with a relaxed dependency indication, i.e. the processing task having that relaxed dependency is permitted to start its operation but is controlled during that operation with a dependency upon a status of an other processing task.

The other processing task may in some embodiments be performed by other processing circuitry to the processing circuitry which performs the processing task having the relaxed dependency. This other processing circuitry may comprise a plurality of processing units with each of these processing units serving to process a part of the other processing task. In this way parallelism in performing the other processing task may be improved.

The present techniques are well suited to the field of graphics processing and in this context the apparatus may comprise a graphics processing apparatus and the processing task may comprise a graphics processing task performed upon graphics primitives. An example of a relaxed dependency in this circumstance is when the other processing task is a transform task performed upon vertex data forming vertex points of a plurality of graphic primitives which are subject to a processing operation performed by a graphics processing task having the relaxed dependency upon the transform task.

In this example the status of the transform task used to control the graphics processing task performed on the graphics primitives may be that the transform task has generated a predetermined portion of the plurality of vertex points that includes any vertex points presently required as inputs to the graphics processing task having the relaxed independency. It will be appreciated that vertex points may be required as inputs to many different forms of graphics processing operations.

Another form of relaxed dependency between graphics processing tasks may be when those graphics processing tasks have a predetermined order. In this context, the status of the other graphics processing task which precedes the graphics processing task having the relaxed dependency is that the other graphics processing task has reached a predetermined state within a processing pipeline, e.g. has at least already entered the processing pipeline which will also be used by the graphics processing task having the relaxed dependency.

The task specifiers may be conveniently distributed from the task manager using a messaging protocol. This messaging protocol may also be used to report the status of the other processing task.

It will be appreciated that a processing task may have a dependency upon more than one other processing task. A balance is needed between the size of the task specifier and the number of dependencies to be accommodated. In this context, a task specifier including two fields identifying two processing tasks each being an other processing task upon which the processing task of that task specifier is dependent may be utilised. The task specifier may include a field specifying whether a processing task has a relaxed dependency upon the other processing task or a strict dependency upon the other processing task.

Viewed from another aspect the present invention provides an apparatus for processing data comprising:

processing means for performing a processing task specified by a task specifier; and

task manager means for issuing said task specifier to said processing means, said task specifier identifying zero, one or more dependencies between said processing task and other processing tasks; wherein

when said task specifier identifies a relaxed dependency between said processing task and a other processing task, said processing means is responsive to said relaxed dependency:

(i) to control performing of said processing task by said processing means in dependency upon a status of said other processing task; and

(ii) to permit said processing means to start performing said processing task before completion of said other processing task.

Viewed from a further aspect the present invention provides a method of processing data comprising the steps of:

issuing a task specifier; and

in response to said task specifier, performing a processing task specified by said task specifier, said task specifier identifying zero, one or more dependencies between said processing task and other processing tasks; wherein

when said task specifier identifies a relaxed dependency between said processing task and a other processing task:

(i) controlling performing of said processing task in dependency upon a status of said other processing task; and

(ii) permitting performing said processing task before completion of said other processing task.

It will also be appreciated that the current techniques may be used within a virtual machine implementation of hardware that directly applies these techniques. Such virtual machine implementations are encompassed within the scope of the present techniques.

The above, and other objects, features and advantages of this invention will be apparent from the following detailed description, of illustrative embodiments which is to be read in connection with the accompanying drawings.

### BRIEF DESCRIPTION OF THE DRAWINGS

FIG. 1 schematically illustrates a graphics processing apparatus including a task manager and processing circuitry for performing graphics processing operations;

FIG. 2 schematically illustrates a data structure for a task specifier;

FIG. 3 is a flow diagram schematically illustrating the control of processing in accordance with the dependency specified within a task specifier;

FIG. 4 schematically illustrates one form of strict dependency;

FIG. 5 schematically illustrates one form of relaxed dependency;

FIG. 6 schematically illustrates a further form of strict dependency;

FIG. 7 schematically illustrates a further form of relaxed dependency;

FIG. 8 schematically illustrates a graphics processing pipeline in which a state variable generated in one processing stage is consumed within a preceding processing stage;

FIG. 9 schematically illustrates an example of no dependency between processing tasks; and

FIG. 10 schematically illustrates a virtual machine embodiment.

### DESCRIPTION OF THE EMBODIMENTS

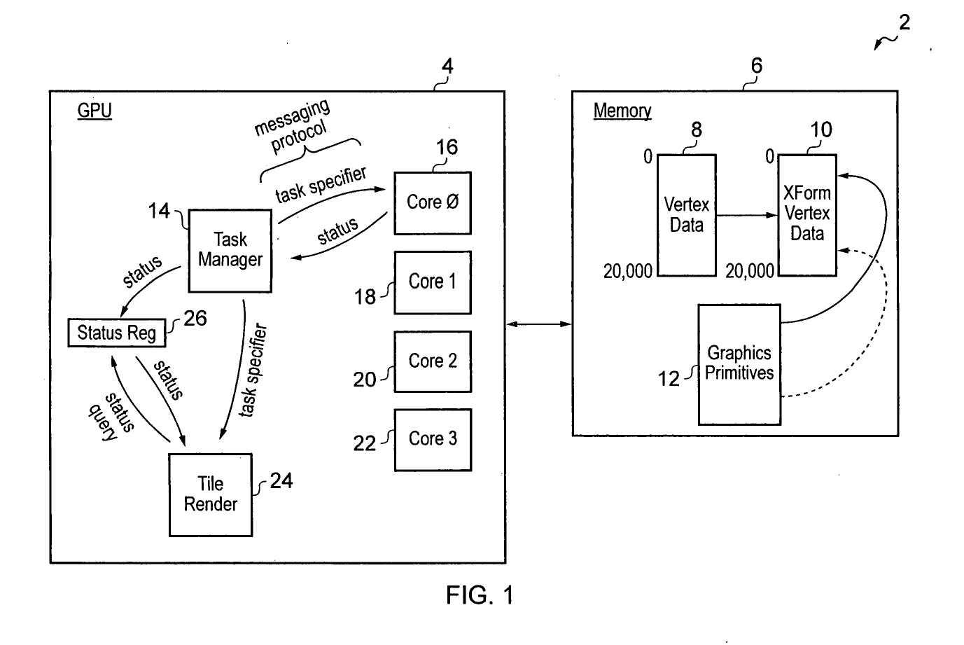

FIG. 1 schematically illustrates a processing apparatus 2 comprising a graphics processing unit 4 coupled to a memory 6. The memory 6 stores graphics data to be manipulated by the graphics processing unit 4. This graphics data includes vertex data 8, transformed vertex data 10 generated by a transform task or tasks performed on the vertex data 8 as well as graphics primitive data 12 specifying indexes to transformed vertex data 10 defining graphics primitives to be drawn.

The graphics processing unit 4 includes task manager circuitry 14 and processing circuitry formed of multiple programmable cores 16, 18, 20, 22. Tile rendering processing circuitry 24 is responsible for tile rendering tasks under control of the task manager circuitry 14. A status register 26 is provided for storing status data indicating the status of processing tasks being performed by the cores 16, 18, 20, 22 for use in controlling processing being performed by the tile rendering processing circuitry 24.

As an example of processing operations to be performed, the task manager circuitry 14 may issue a task specifier to one of the cores 16, 18, 20, 22 specifying a vertex transformation processing task. This task specifier may be passed using a messaging protocol to the core 16, 18, 20, 22 and any status value returned from that processing core 16, 18, 20, 22 may also utilise that messaging protocol in returning the status information to the task manager circuitry 14.

In the example illustrated, the vertex data may contain 20,000 vertex points all to be subject to a transform operation using a three-dimensional matrix manipulation. This overall processing workload may be broken down into multiple processing tasks to be divided between the cores 16, 18, 20, 22. Each of these processing tasks may be issued with a task specifier to the processing core 16, 18, 20, 22 to perform that portion of the overall vertex transformation. The transformed vertex data is written into the region 10 within the memory 6 as illustrated. The tile rendering processing circuitry 24 reads that transforming vertex data 10 in performing an other graphics processing task, such as tiling.

This tiling task will normally be arranged such that it will first consume the transformed vertex data that was first generated in the vertex transformation task. Accordingly, there is no need to wait until the last of the transformed vertex data 10 (e.g. vertex point 20,000) has been generated before the tiling task is started. The tiling task may have a relaxed dependency upon the vertex transformation task requiring a particular portion of that vertex transformation task to have been generated before a corresponding portion of the tiling task is triggered to consume that portion of the transformed vertex point data. Thus, if the vertex transformation is split into four tasks each transforming 5,000 vertex points, then the tiling task may be controlled such that the first portion of the tiling task is able to start executing once the first 5,000 transformed vertex points have been generated as is indicated by the status value returned from the core 16, 18, 20, 22 performing that transformation and reported via the status register 26 to the tile rendering processing circuitry 24. The tiling processing requiring the vertex points in the range 5,000 to 10,000 can be controlled such that it does not commence its operation until the status value within the state register 26 indicates that the vertex transformation has completed up to the 10,000 vertex point position. In this way, the tiling operation can be overlapped with the vertex transformation operation.

Other examples of graphics processing tasks which may be subject to relaxed dependencies are ones which must be executed in order (e.g. a state variable associated with one processing task is consumed by an immediately following processing task) but may be overlapped. In this circumstance, the relaxed dependency can indicate that the processing task may be started (e.g. to perform some initial setup operations) but may not be committed to the processing pipeline until a preceding processing task has been committed to that processing pipeline. Once the two processing tasks are in the processing pipeline, then they may proceed in order along the processing pipeline and will not violate their dependency. Using their relaxed dependency indication in the task specifier allows these processing tasks to be overlapped rather than requiring the other processing task to have fully completed its operation (i.e. exited the pipeline) before the processing task having the task specifier including the relax dependency is allowed to be sent to the processing pipeline.

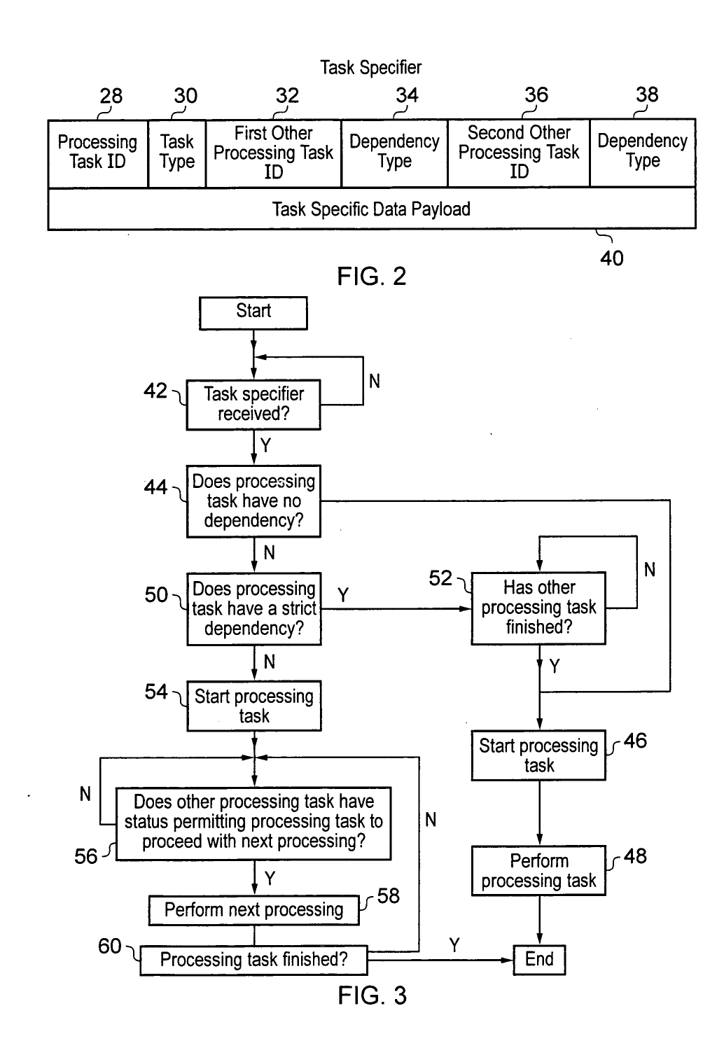

FIG. 2 schematically illustrates an example form of a task specifier passed via the messaging protocol used within the graphics processing unit 4. This task specifier includes a processing task identifier 28 for the task being controlled by that task specifier. A task type 30 indicates the type of a task to be performed. A first other processing task identifier 32 and a dependency type field 34 indicate a first other processing task upon which there is either a strict dependency or a relaxed dependency. The dependency type field 34 indicates whether the dependency is a strict dependency or a relaxed dependency. A second other processing task identifier 36 and a second dependency type field 38 include the ability to specify a dependency upon a second other processing task. Task specific data payload 40 is also associated with the task specifier. The task specifier may thus directly represent zero, one or two dependencies. A task to which a dependency is indicated may be dependent upon one or more other tasks allowing greater than two dependencies to be represented using task specifiers.

The nature of the dependency indicated by a relaxed dependency being specified is derived from a combination of the dependency field 34, 38 and the task type 30. Thus, for one task type a relaxed dependency may indicate a certain requirement and control using a status of an other processing task while for another task type a different status requirement and control is performed. The hardware or software controlling the processing circuitry performing the processing task having the relaxed dependency can read the task type 30 and the dependency field 34, 38 to determine what type of control based upon the status of the other processing task is to be performed.

FIG. 3 is a flow diagram schematically illustrating control performed in dependency upon the type of dependency specified when a task specifier is received by processing circuitry. At step 42 the processing circuitry waits until a task specifier is received. At step 44 a determination is made as to whether or not the task specifier indicates that there is no dependency. If no dependency is indicated, then processing proceeds to step 46 where the processing task is started. Step 48 then performs the processing task.

If the determination at step 44 was that the processing task is not a “no dependency” processing task, then processing proceeds to step 50. Step 50 identifies whether there is a strict dependency. If there is a strict dependency, then step 52 waits until the other processing task identified in the relevant other processing task identifier field 32, 36 has finished. Once this other processing task has finished, then step 46 starts the processing task and step 48 performs the processing task.

If the determination at step 50 is that the processing task does not have a strict dependency, then the remaining option is that the processing task has a relaxed dependency. In this case, step 54 starts the processing task having the relaxed dependency. The first operations performed on starting the processing task may be set up operations rather than operations actually consuming input data. Step 56 then determines whether the other processing task upon which the relaxed dependency exists has the status which permits the processing task received at step 42 to proceed with its next phase of processing. The nature of the status requirement can be determined from the task type field 30. Once this requirement is met, step 58 performs the next portion of the processing for the processing task received at step 42. Step 60 determines whether or not the processing task received at step 42 has finished. If the processing task received at step 42 has not finished, then processing returns to step 56 where a further check is made as to whether or not the other processing task upon which there is a dependency now has a status indicating that the next portion of the processing may be performed. Thus, the processing associated with the processing task received at step 42 is started at step 54 without waiting for the other processing task upon which there is a dependency to complete its operation and then the further advancement of that processing task is controlled in dependency upon a status reported from the other processing task as determined at step 56. This increases the degree of parallelism which may be achieved whilst respecting any dependency that does exist.

It will be appreciated that FIG. 3 illustrates the situation in which a processing task has a dependency only in relation to one other processing task. As indicated in FIG. 2, in some embodiments it may be convenient to provide for dependency upon two or more other processing tasks. In this circumstance, a variation of the control illustrated in the flow diagram of FIG. 3 may be employed in which if any strict dependency is present, then the processing task will not be started until the other processing task upon which there is that strict dependency has completed. Once any strict dependency has been dealt with, then processing of the task will start and will proceed up to the point of any status requirement indicated by any relaxed dependency not being met.

It will be appreciated that the task specifier may indicate a variety of different combinations of dependency. No dependency may be indicated by a predetermined value within an other processing task identifier 32, 36, e.g. a task identifier of zero may indicate that no dependency is being indicated in relation to that other task identifier. If an other task identifier is non-zero, then the value of the dependency type field 34, 38 will indicate whether or not the dependency is a strict dependency or a relaxed dependency. If the dependency is a relaxed dependency, then the form of this dependency will be controlled by the relationship between the task type identified within the task specifier and the task type associated with the other processing task concerned. Thus, there are a relatively large number of permutations between the different number and different types of dependencies which can be specified by a single task specifier.

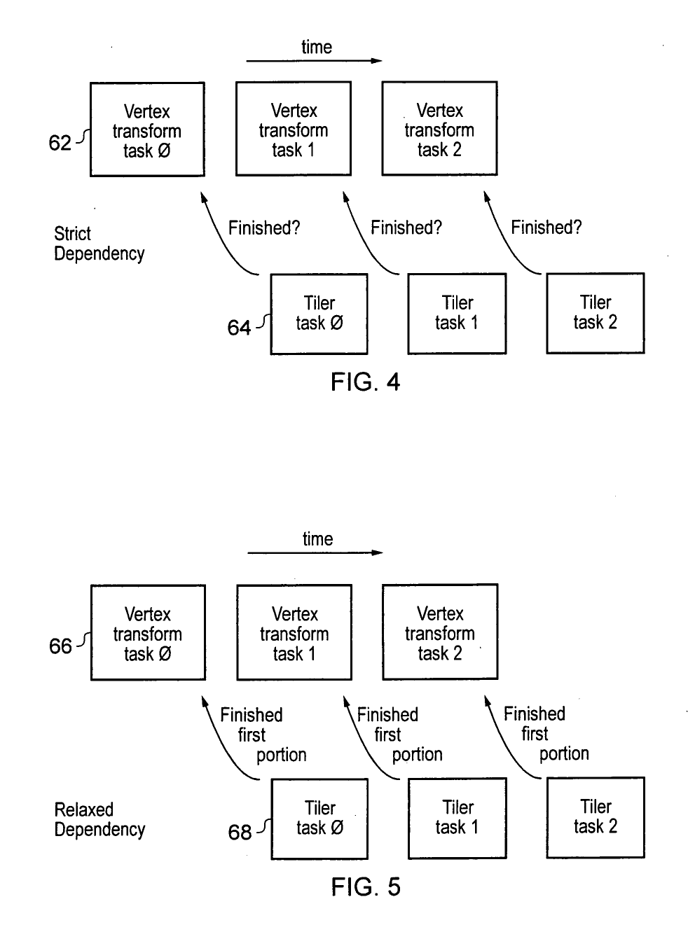

FIG. 4 schematically illustrates one type of strict dependency. In this strict dependency, a vertex transformation task 62 generates transformed vertex data which is to be consumed by tiler task 64. The strict dependency does not permit the tiler task 64 to start its processing until the vertex transformation task 62 has completed.

FIG. 5 illustrates a relaxed dependency between a vertex transformation task 66 and a tiler task 68. In contrast to the strict dependency illustrated in FIG. 4, the relaxed dependency of FIG. 5 permits the tiler task 68 to start its operation once the first portion of the vertex transformation task 66 has completed. The tiler task 68 will normally be arranged such that it consumes the vertex data in the same order in which it is generated by the vertex transformation task 66. Thus, a small offset between the start of the vertex transformation task 66 and the start of the tiler task 68 may be sufficient to allow both to proceed uninterrupted. However, if the tiler task 68 does require some vertex data which has not yet been generated by the vertex transformation task 66, then the tiler task 68 may be stalled until the status of the vertex transformation task (e.g. a value indicating its progress in generating the transformed vertex data) indicates the dependency requirement is met.

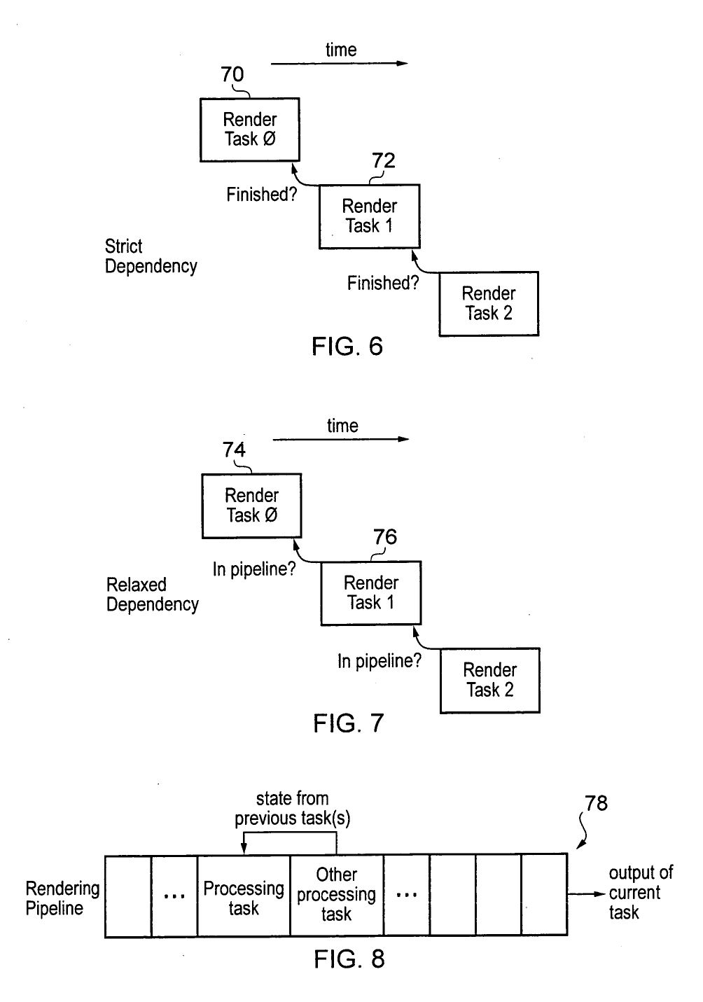

FIG. 6 illustrates another form of strict dependency. In this example all of the tasks are of the same type. There is a dependency requirement that the tasks are performed in a predetermined sequence. When this requirement is expressed using a strict dependency, then the result is that task 70 must have finished before task 72 is permitted to start. FIG. 7 illustrates how a relaxed dependency may be used to meet this same requirement, but permit an overlapping of the task. Given that the tasks are to be processed in a processing pipeline that does not permit reordering, task 76 may be started once task 74 has entered the processing pipeline. There may be other types of relaxed dependency which concern a state variable or output of one task being consumed by a following task. Depending upon the time separation within the processing pipeline between the generation of the state variable or output and the point at which it is consumed, this may be used to establish a minimum separation within the processing pipeline of the tasks concerned. Thus, a relaxed dependency in this circumstance may specify that the preceding task is at least a predetermined number of processing stages along the processing pipeline before the immediately following processing tasks can be started in the processing pipeline. Thus, the state variable or output of the preceding processing task will be generated and available for use by the succeeding processing task in time when the succeeding processing task reaches the relevant point within the processing pipeline.

FIG. 8 schematically illustrates a processing pipeline 78 of the type discussed in relation to FIG. 7. In this processing pipeline it will be seen that a state variable from an other processing task is fed back to a processing task having a relaxed dependency upon that other processing task. In this example the state variable is only fed back by one processing state and accordingly providing the other processing task has already started within the processing pipeline 78, then the processing task may also be issued into the pipeline 78 as it will then always be at least one processing stage behind the other processing task.

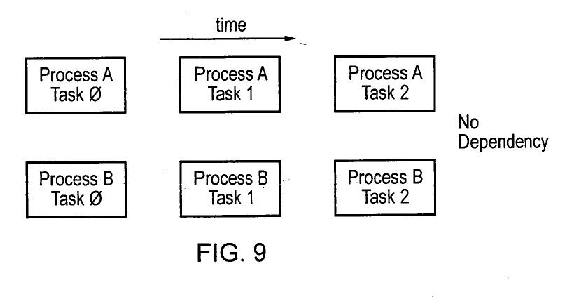

FIG. 9 schematically illustrates the circumstance in which there is no dependency between processing tasks. In this example a process A forms a sequence of tasks 0, 1, 2. A process B performs a sequence of tasks 0, 1, 2 having no dependency upon the tasks of process A. Thus the tasks of process B can be issued at any time relative to the tasks of process A.

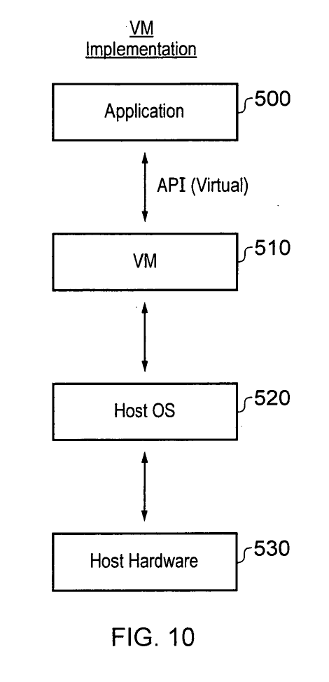

FIG. 10 illustrates such a virtual machine implementation that may be used. Whilst the earlier described embodiments implement the present invention in terms of apparatus and methods for operating specific processing hardware supporting the techniques concerned, it is also possible to provide so-called virtual machine implementations of hardware devices. These virtual machine implementations run on a host processor 530 running a host operating system 520 supporting a virtual machine program 510. Typically, large powerful processors are required to provide virtual machine implementations which execute at a reasonable speed, but such an approach may be justified in certain circumstances, such as when there is a desire to run code native to another processor for compatibility or re-use reasons. The virtual machine program 510 provides an application program interface to an application program 500 which is the same as the application program interface which would be provided by the real hardware which is the device being modelled by the virtual machine program 510. Thus, the program instructions, including the control of memory accesses described above, may be executed from within the application program 500 using the virtual machine program 510 to model their interaction with the virtual machine hardware.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
processing circuitry configured to respond to a task specifier to perform a processing task specified by said task specifier; and
a task manager configured to issue said task specifier to said processing circuitry, said task specifier identifying zero, one or more dependencies between said processing task and other processing tasks; wherein
when said task specifier identifies a relaxed dependency between said processing task and an other processing task, said processing circuitry is responsive to said relaxed dependency:
(i) to control performing of said processing task by said processing circuitry in dependency upon a status of said other processing task; and
(ii) to permit said processing circuitry to start performing said processing task before completion of said other processing task.

2. Apparatus as claimed in claim 1, wherein when said task specifier identifies a strict dependency between said processing task and a different processing task, said processing circuitry is responsive to said strict dependency to prevent said processing circuitry from starting to perform said processing task before completion of said different processing task.

3. Apparatus as claimed in claim 1, wherein when said task specifier identifies no dependency between said processing task and any other processing task, said processing circuitry starts to perform said processing task without any dependency upon said any other processing task.

4. Apparatus as claimed in claim 1, wherein said other processing task generates a plurality of outputs and said status of said other processing task is that said other processing task has generated a predetermined portion of said plurality of outputs.

5. Apparatus as claimed in claim 4, wherein said plurality of outputs are generated in a predetermined sequence and said status corresponds to outputs being generated up to a predetermined position in said predetermined sequence.

6. Apparatus as claimed in claim 4, wherein said processing task requires as inputs one or more of said plurality of outputs within said predetermined portion.

7. Apparatus as claimed in claim 1, wherein said status of said other processing task is that said other processing task will generate one or more state variables at least in time for said one or more state variables becoming required for use by said processing task.

8. Apparatus as claimed in claim 7, wherein said other processing task and said processing task access a sequence of data items in order and access to said sequence by said other processing task updates a pointer value, said pointer value indicating an access position within said sequence, and said pointer value is required by said processing task to access said sequence.

9. Apparatus as claimed in claim 1, comprising other processing circuitry configured to perform said other processing task.

10. Apparatus as claimed in claim 9, wherein said other processing circuitry comprises a plurality of processing units, each of said plurality of processing units serving to process a part of said other processing task.

11. Apparatus as claimed in claim 1, wherein said apparatus is a graphics processing apparatus, said processing task comprises a graphics processing task performed upon graphics primitives and said other processing task is a transform task performed upon vertex data forming vertex points of said plurality of graphics primitives.

12. Apparatus as claimed in claim 11, wherein said status of said transform task is that said transform task has generated a predetermined portion of said plurality of vertex points, said predetermined portion including any vertex points required as inputs to said graphics processing task.

13. Apparatus as claimed in claim 1, wherein said apparatus is a graphics processing apparatus, said processing task comprises a graphics processing task having a predetermined position within a sequence of graphics processing task to be performed in a predetermined order and said other processing task comprising an other graphics processing task having a position within said sequence immediately preceding said predetermined position.

14. Apparatus as claimed in claim 13, wherein said other graphics processing task and said graphics processing task are processed in a processing pipeline said status of said other graphics processing task is that said other graphics processing task has reached a predetermined stage of said processing pipeline.

15. Apparatus as claimed in claim 1, wherein said task manager issues said task specifier to said processing circuitry using a messaging protocol.

16. Apparatus as claimed in claim 15, wherein said status of said other processing task is also communicated using said messaging protocol.

17. Apparatus as claimed in claim 1, wherein said task specifier includes two fields identifying two processing tasks each being an other processing task upon which said processing task is dependent.

18. Apparatus as claimed in claim 2, wherein said task specifier includes a field specifying whether said processing task has a relaxed dependency upon said other processing task or a strict dependency upon said other processing task.

19. Apparatus for processing data comprising:
processing means for performing a processing task specified by a task specifier; and
task manager means for issuing said task specifier to said processing means, said task specifier identifying zero, one or more dependencies between said processing task and other processing tasks; wherein
when said task specifier identifies a relaxed dependency between said processing task and a other processing task, said processing means is responsive to said relaxed dependency:
(i) to control performing of said processing task by said processing means in dependency upon a status of said other processing task; and
(ii) to permit said processing means to start performing said processing task before completion of said other processing task.

20. A method of processing data comprising the steps of
issuing a task specifier; and
in response to said task specifier, performing a processing task specified by said task specifier, said task specifier identifying zero, one or more dependencies between said processing task and other processing tasks; wherein
when said, task specifier identifies a relaxed dependency between said processing task and a other processing task:
(i) controlling performing of said processing task in dependency upon a status of said other processing task; and
(ii) permitting performing said processing task before completion of said other processing task.

21. A virtual machine configured to provide a processing environment in accordance with said apparatus of claim 1.
